(19) United States
(12) Patent Application Publication
(10) Pub. No.: US 2003/0007018 A1
(43) Pub. Date: Jan. 9, 2003

(54) Handwriting user interface for personal digital assistants and the like

(76) Inventors: Giovanni Seni, Mountain View, CA (US); Fahfu Ho, Cupertino, CA (US)

Correspondence Address: MOTOROLA INC, 600 NORTH US HIGHWAY 45, LIBERTYVILLE, IL, 60048-5343, US

(21) Appl. No.: 09/901,878

(22) Filed: Jul. 9, 2001

(51) Int. Cl. G09G 5/00

(52) U.S. Cl. 345/864

(57) ABSTRACT

A handheld device (100), a graphical handwriting user interface (“HUI”), a method of interfacing handwritten text and a program product therefor. A lower portion of a touch-enabled display is designated as a handwriting input area (104). Recognized text is displayed at the top of the screen. As each handwritten word is entered (142) into the designated screen input area, a check is made (144) to determine when the handwritten entry is complete by pressing a space key or by a special pen gesture. When the handwritten entry is complete, the handwriting recognition engine matches (146) the handwritten input against words in the system dictionary as supplemented by the user dictionary and a confidence score is attached (148) to the top scoring word.

### BACKGROUND OF THE INVENTION

1. Field of the Invention

The present invention is related to personal digital assistants (PDAs) and more particularly to a user input interface for a PDA or the like.

2. Background Description

Portable computing devices, such as what is normally referred to as a personal digital assistant (PDA), are increasing in popularity. A typical PDA is a limited function microcomputer provided with a pressure sensitive liquid crystal diode (LCD) display (a touch pad or a touch screen) for input and output (I/O). PDAs are being adapted for wireless Internet communication, e.g., using a modem for e-mail and web browsing. Further, for text input PDAs are known that have a specialized stroke based alphabet interface, e.g., Graffiti®, a selectable on-screen QWERTY keypad, or an expansion pack keyboard.

As these portable devices become smaller and more specialized, text input has become more difficult and less practical. Typical prior art handwriting recognition software may require users to learn special characters or effect a handwriting style in order to enter text. Text input using the Graffiti® unistroke (i.e., written with a single pen trace) alphabet can be un-natural because it requires users to adhere to strict rules that restrict character shapes; text input using an on-screen QWERTY keypad is somewhat clumsy because only small reductions in size can be made to keyboards before they become awkward to use. An expansion keyboard is impractical for on the-go input. With either, the tapping on individual characters or the typing is less desirable than being able to handwrite notes or messages. Meanwhile, the demand for PDA information exchange, e-mail and internet access requires entry and retrieval of increasing amounts of data with the handheld device.

Natural handwriting recognition (HWR) programs have been developed to add to function and usefulness to PDAs and are crucial to the growth of mobile computing in the communications field. To use such handwriting recognition software, such as Transcriber (formerly known as Calligrapher) from Microsoft Corporation, the user is allowed to write a message anywhere on the screen, i.e., on top of any displayed application and system elements. Once the text is corrected, it may be embedded in the e-mail message, for instance, and, the next sentence or string of words can be entered. However, typically, correction is deferred until the message or word storing is completed, when the whole string may be displayed, because during input the entire display is used for handwriting input.

However, these write anywhere approaches require a special mechanism to distinguish pen movement events that correspond to handwriting input from pen events that are intended to manipulate user interface elements such as buttons, scroll bars and menus. Often it is difficult to differentiate between these two modes of stylus operation, viz. that of a writing implement for text entry (inking mode) and its control function such as for clicking on application icons and the like (control mode). Another problem with a write-anywhere user interface is that fingers, as the writer is moving his/her hand through the screen, can often interfere with the (pressure-based) pen tracking mechanism. Simultaneous pressure from the stylus and a carelessly positioned pinky finger for instance can cause the device to mislocate the intended stylus entry point, e.g., the device may use the average of the two contact locations. These shortcomings can lead to text input errors and the attendant aggravation and input delays caused by such errors.

Typically, these state of the art handwriting recognition programs exhibit a top-n recognition accuracy of around 85% (top-1) and 95% (top-5), where top-n recognition accuracy is a measure of how often the correct answer is among the highest ranked n results. An 85% recognition accuracy, where one in six words is misrecognized, is not particularly tolerable for many users. However, at higher recognition rates of 95% and above, where only 1 in 20 words is misrecognized, users are more inclined to use handwriting recognition software. Therefore, easy access to recognition alternates—i.e., top-n results, is a very important HWR feature.

An additional user interface issue with a write-anywhere text input paradigm is that there are usually no input method control elements visible anywhere on the screen. For instance, access to recognition alternates might require a special pen gesture. As such, a write-anywhere interface generally is not very appealing to less advanced users. Furthermore, recognition in the write-anywhere case is more difficult because there is no implicit information provided to the recognition engine regarding word separation, orientation, or size of the text.

Thus, there is a need for handwriting input user interface that easily distinguishes between control mode and inking mode of the pen, that allows easy access to recognition alternatives, and that enables accurate recognition of handwritten words.

### BRIEF DESCRIPTION OF THE DRAWINGS

The foregoing and other objects, aspects and advantages will be better understood from the following detailed preferred embodiment description with reference to the drawings, in which:

FIG. 1 shows a preferred embodiment handheld device with a graphical handwriting user interface according to preferred embodiment of the present invention;

FIG. 2 shows an example of the handwriting user interface (HUI) displaying a word correction keyboard for manually correcting a handwritten word;

FIG. 3 is a flow diagram of an example of a method for implementing the handwriting user interface of the preferred embodiment of the present invention.

### DETAILED DESCRIPTION OF PREFERRED EMBODIMENTS

The present invention is a method of interfacing with and a handwriting user interface (HUI) for small (pocket-shirt sized) portable devices with a touch-enabled input/output (I/O) screen, such as are commonly known as personal digital assistants (PDAs). The portable devices may be capable of wireless message transmission (such as for web browsing and/or e-mail). The user interface of the present invention is typically in software and loaded into PDA storage. A state of the art handwriting recognition engine also is included in software. The handwriting user interface of the present invention enhances the usability, flexibility and power of the handheld device in which it is installed. An entire message may be quickly handwritten, converted, stored and then, transmitted, for example.

FIG. 1 shows a preferred embodiment pocket sized handheld device 100 with a housing 101 graphical handwriting user interface 102 according to preferred embodiment of the present invention. A lower portion of the display is designated as a handwriting input area 104. In the illustrated and preferred form, the housing 101 has a compact pocket sized form with a rectangular configuration having dimensions on the order of 120×80 mm with the screen height being 82 mm and the width being 62 mm, for example. Action icons 106, 108, 110, 112 and 114 are disposed at a right side of the handwriting user interface 102. Recognized text is displayed at the top of the screen under a file management tool bar 116. In this embodiment, a scroll bar 118 is disposed at the right side of the interface display 102. As each word is recognized, it is shown inserted into the text at the top of the interface display 102 and, a secondary list of potential recognition candidates may be displayed in a box 120 and offered for substitution for or in lieu of the recognized word. Although the secondary word list box 120 is preferably displayed in the input area 104, in this example it is shown just above the handwriting input area 104.

Handwritten Entries are made at the designated input area 104 on the touch screen, preferably of dimensions 0.30*H by W, where H and W are the height and width of the device screen. The preferred location of the input area is the bottom of the screen 102, so as to only partially block view of any application currently running on the device. Thus, only the stylus is above the input area 104 during entry with the largest portion of the hand resting on the housing 101 therebelow. Handwritten words are entered into the input area 104 one word at a time using a stylus and, recognition results can be displayed in the same input area 104 or in the normal display area of the screen above the input area 104.

The device 100 may include a communications function and, to that end in this embodiment, an antenna 122 is shown at the top of the device 100. Individual function switches, buttons and other controls are disposed about the device, as is deemed appropriate for the particular device. The device 100 may also include an expansion port 124 or an expansion port function may be provided wirelessly through antenna 122. Preferably, the device 100 runs under a state of the art operating system for such handheld devices, e.g. Windows® CE from Microsoft Corporation, Epoc® from Symbian or the Palm OS® from Palm, Inc.

The preferred embodiment HUI of the present invention employs a handwriting recognition engine capable of recognizing handwritten words, written using any combination of writing styles (i.e., cursive, print, and mixed) to improve throughput on text entry, as it allows a more natural writing style to be employed versus, for example, engines that require only individual characters requiring a pause between each as it is entered. Preferably, the recognition engine is the QuickPrintPro engine from Motorola, Inc., Lexicus division. The recognition engine typically includes a main dictionary and a user dictionary to which the user may add words to supplement the main dictionary. The recognition engine compares a handwritten input word against all words contained in the main dictionary and the user dictionary. A probability score is generated by the recognition engine for each dictionary word which is indicative of the likelihood that the handwritten word matches that particular dictionary word. Based on each words' probability score, a list of likely matches is collected.

From the recognition results, the handwriting recognition engine calculates a confidence level for the one word (the primary word) with the highest probability. If that confidence level exceeds a preselected or confidence threshold, it is taken as an indication that the word with the highest probability is in fact correct and the highest scoring word is displayed as the primary word choice. All other results are referred to as secondary word choices and may be included in the pop-up list in box 120. So, if the confidence level is above the preselected threshold, the HUI automatically loads a primary word choice into the device's input buffer for delivery to the active application. Otherwise, when the confidence level of the primary word choice is below the confidence threshold, an indication is provided that the recognition engine cannot find a likely candidate, e.g., displaying “???” or something similar into the device's input buffer. The primary and secondary word choice may be displayed in the pop-up list box 120.

The number of words, n, listed in the pop-up list 120, is user selectable and generally is small enough (5) that the pop us list is contained within the input area 104. Providing ready access to word recognition results in the pop-up list increases the likelihood that the correct word is, at the very least, included in the group of top-n words in box 120. Thus, the word recognition rate is generally higher for the group than the overall individual word recognition rate. The word group recognition rate improvement may be as much as 10%. Therefore, presenting the top-n results to the user, where n is typically 5, improves the likelihood that the correct word is displayed, even if the correct word is not the top scoring entry. The correct word may be selected from the group nearly as quickly as accepting a correctly recognized word. Each newly selected word choice is loaded into the system input buffer, and the previously misrecognized word, if any, is deleted from the buffer.

Action icons 106, 108, 110, 112, 114 are displayed to provide virtual buttons for editing any previously entered text. Preferably, the icons are displayed together at any side of the input area (e.g., left, right, top or bottom). Editing operations may include, but are not limited to: insert a space 108, backspace 112, delete 114, capitalize recognition result 110, and undo insertion of last recognition result 106. Further, as each word is entered and recognized, a stylus may be used to select one or more characters of the word in a text field of the active application. The preferred recognition engine is also capable of recognizing individual stand-alone characters. At any time, the user can select one (or more) character(s) from a previously entered word and write a new character(s) in the input area with the result replacing the selected text. Optionally, the editing icon 106 can automatically select a correction keyboard which may be used to edit the last recognition result. When selected, the correction keyboard is displayed in the input area 102.

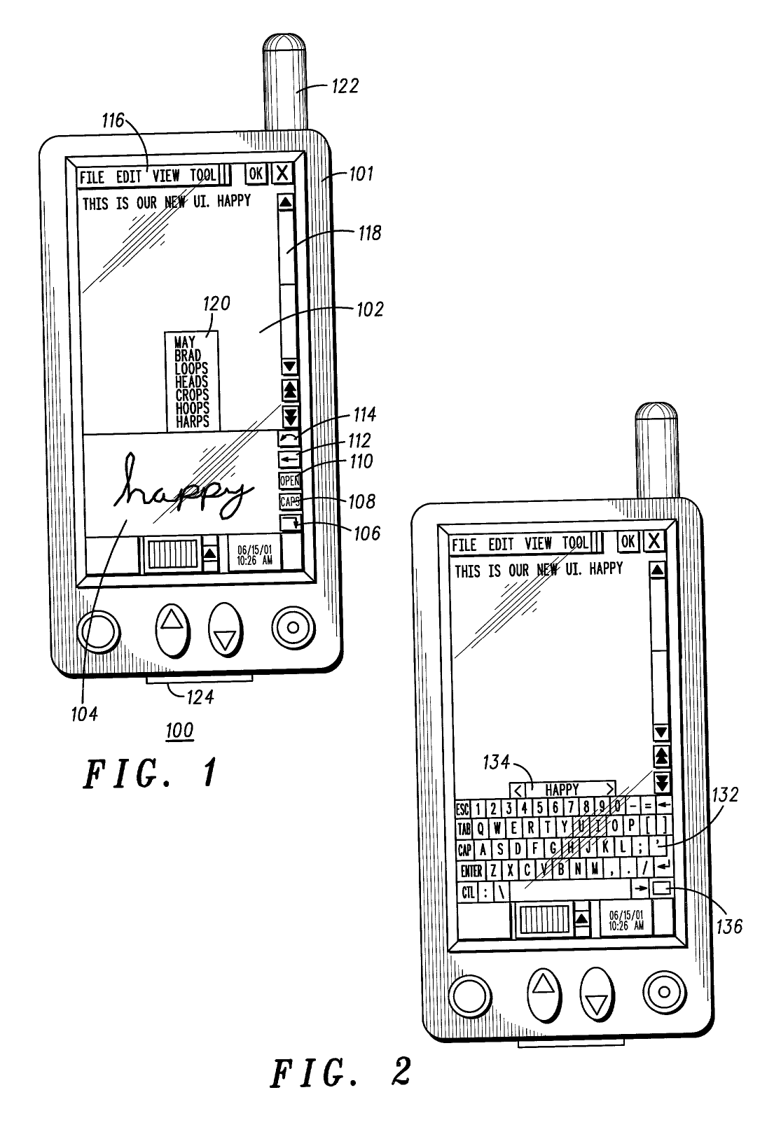

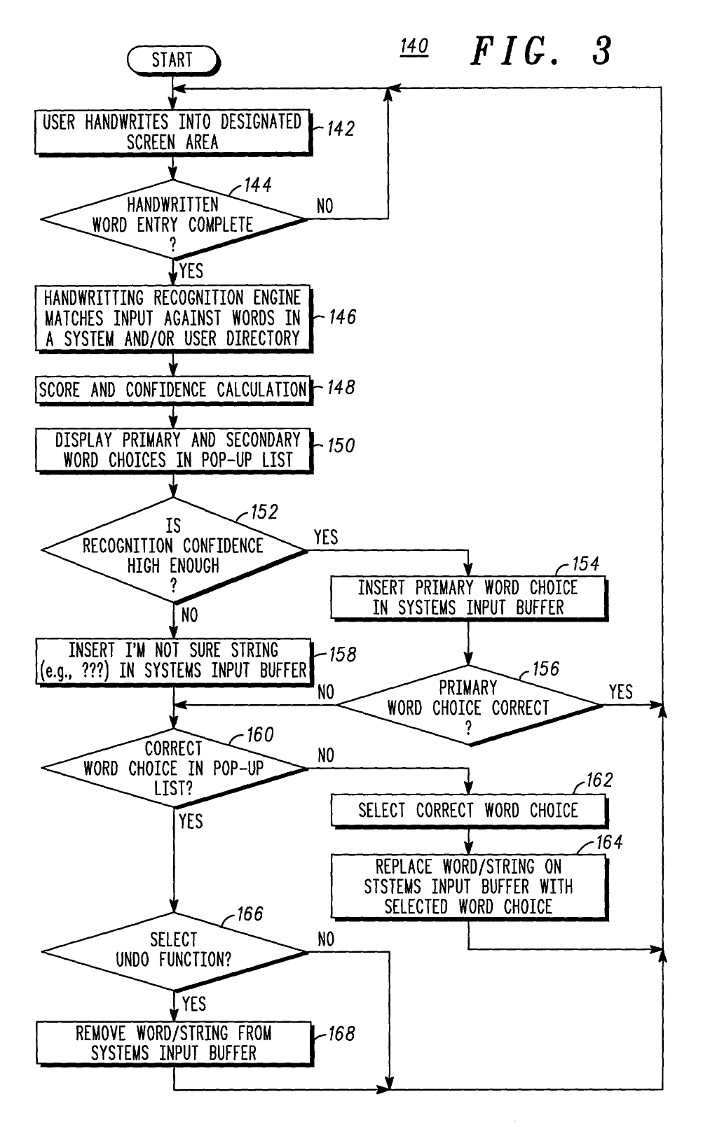

FIG. 2 shows an example of the preferred embodiment HUI displaying a word correction keyboard for manually correcting a handwritten word recognition result. In this mode, the user interface displays a QWERTY keyboard 132 in the input area and a word correction window 134. The previously input text is displayed at the top of the screen. Each word is entered and the last recognition result remains displayed for editing in the editing area. As noted above, a single word can be selected or, individual letters within the word may be selected and corrected using the QWERTY keyboard 132. A special purpose key or button 136 may be included in the correction keyboard 132 for inserting the corrected word or substitute word into the user dictionary for inclusion in subsequent recognition.

Additional icons (not shown) may be included on the display to allow the user to change selected configuration settings. Configuration settings may include handwriting style preferences and recognition options. Typical recognition options may include an option to propose upper-case at the beginning of a word, an option to suggest end of word punctuation, the number of recognition results displayed in the pop-up list, the location of editing buttons (i.e., left or right hand side of the input area), and user dictionary maintenance, i.e., viewing, adding, and/or deleting entries. The option to propose upper-case may be such that, if set, the recognition engine attempts to recognize the input with and without a leading upper-case letter. The option to suggest punctuation also may be included such that the recognition engine may be directed to recognize punctuated handwritten input, automatically discerning when trailing punctuation marks are included. Punctuation mark recognition is simpler in the context of a word. A period, for instance, written by itself is merely meaningless and could be interpreted as anything. However, small digital ink point at the end of a word is much easier to identify and classify as a punctuation mark, e.g. a period, comma, etc.

Handwritten input entry may be provided in unrestricted mixed style that includes cursive (i.e., contiguous characters in each word touching or connected), pure print (i.e., characters in every word disconnected and do not touch), pseudo-print (at most pairs of characters in words touch) or any combination thereof. Thus, for mixed entry, the user is not restricted to cursive, print or pseudo-print inputs. However, to facilitate recognition accuracy and entry speed, the user may designate that entry is to be in one mode only, i.e., cursive, pure print or pseudo print. By thus designating entry mode, the number and complexity of created character alternatives possible may be reduced for the handwriting recognition engine, increasing both recognition accuracy and speed.

Single word-at-a-time input recognition is advantageous over character-at-a-time recognition for text input in these kind of devices, because it enables higher writing throughput when composing messages. Further, single word input in the designated input area is more desirable than writing multiple words or sentences anywhere on the screen, for example, because it is much more structured, simpler to use and, therefore, leads to more predictable and consistent results. Recognition errors are avoided that could otherwise result from segmenting an input string into words and from corresponding conflicts. These errors and conflicts also result from the inherent ambiguity of inputting with a single pointing device, i.e., a stylus, wherein the stylus is used both as an inking pen for writing and, as a mouse-type pointing device for function selection. For example, the device must distinguish between an inking stroke and scrolling the screen by dragging the stylus. By designating an input area for writing, such conflicts are resolved simply: the stylus functions as an inking pen inside the writing area and as a non-inking pointing device/mouse outside of the input area.

FIG. 3 shows a flow diagram of an example of a method 140 for implementing the handwriting user interface of the preferred embodiment of the present invention. First, in step 142 a handwritten word is entered into the designated screen input area. In step 144 a check is made to determine when the handwritten entry is complete; this is typically done with a timer, by pressing a space key or by a special pen gesture. When the handwritten entry is complete, continuing to step 146, the handwriting recognition engine matches the handwritten input against words in the system dictionary as supplemented by the user dictionary. In step 148 a confidence score is attached to the top scoring word. In step 150, the highest scoring words are selected from the dictionaries and displayed in the pop-up list 120.

In step 152 a confidence level for the top scoring word is checked to determine if it exceeds the confidence threshold and so, scores high enough to be accepted as a positive indication of having identified the handwritten word. So, if the confidence level is high enough in step 154, then, it is inserted in the input buffer as primary word choice for that handwritten word. In step 156 the user is allowed to decide whether the primary word is correct and, if so, returning to step 142, the user can enter a next word. If, in step 152, the confidence level is not high enough, then in step 158, the user is prompted with an indication that the recognition result is less reliable; in the preferred embodiment, this indication is in the form of a special question mark string (“???”) which is inserted in the input buffer, but it could be an audible signal, or any other suitable indication.

In step 160, the pop-up list provided to the user includes the primary word, if any, as the top choice along with the next n−1 highest scoring words so that the user may examine the n highest scoring words. If the correct word is included in the popup list, then continuing to step 162, the user can select the correct word. In step 164 that selected word is inserted into the text stream, either to replace the previously provided primary word or as an original word replacing the “???” string and returning to step 142, the user is allowed to enter a next word.

However, if in step 160, the correct word is not listed in the pop-up list then, in step 166, the user is allowed to undo the entry. If the user selects to undo the entry, then, in step 168 the previously recognized primary word or the “???” string is removed from the device's input buffer and so from the display; and, returning to step 142 the user is allowed to enter a next handwritten word. However, if in step 166, the user selects not to undo the previous word, then again returning to step 142, the user can enter a next word. Note that the HUI communicates with the currently active application through the device's input buffer.

Thus, as can be readily appreciated the HUI of the present invention provides a simple to use, yet elegant handwriting interface for pocket sized devices such as PDAs and the like.

While the invention has been described in terms of preferred embodiments, those skilled in the art will recognize that the invention can be practiced with modification within the spirit and scope of the appended claims.

What is claimed is:

1. A hand-held electronic apparatus having a small housing for ease of transport thereof and to contain control circuitry for running different applications therewith, the apparatus comprising:
a screen on the housing having a predetermined size for displaying information to a user;
handwriting recognition circuitry configured for recognizing single and multiple character words handwritten on the predetermined screen area for high writing throughput;
a predetermined area of the screen less than the predetermined screen size on which handwriting is recognized; and
an input device which cooperates with the screen and underlying circuitry for use in inputting handwriting only in the predetermined screen area and selecting application operations displayed on the remainder of the screen to provide the input device with distinct functions based on where the device is used on the screen.

2. The apparatus of claim 1 wherein the handwriting recognition circuitry is configured to display a predetermined number of output words that are ordered by the circuitry based on likelihood of matching the input handwritten word, the output words being displayed in a menu of word choices each time a word is handwritten in the predetermined screen area.

3. The apparatus of claim 1 wherein the handwriting recognition circuitry is configured to display a predetermined number of output words each having an underlying value associated therewith indicative of the probability of recognition accuracy thereof based on the input handwritten word, the output words being ordered from words having highest to least recognition accuracy probabilities.

4. The apparatus of claim 3 wherein the output words include one word having the highest value amongst the displayed output words, and a predetermined threshold recognition level that is compared to a confidence level for said one word such that if the confidence level exceeds the threshold recognition level the one word is used in the application that is active without requiring user intervention, and if the confidence level does not exceed the threshold recognition level user selection is required from amongst the output words for use in the active application.

5. The apparatus of claim 3 wherein the handwriting recognition circuitry includes at least one dictionary database and having a user interface therewith for inputting changes to the database based on low recognition values for handwritten words indicative of the absence of the words from the database.

6. A handwriting recognition user interface (HUI) for a portable device having a touch-enabled input screen, said HUI comprising:
a handwriting input area residing in a portion of a touch-enabled input screen, handwritten words being entered, one at a time using a stylus, recognition results being displayed in said handwritten input area;
a recognition engine capable of recognizing handwritten words; and
a main dictionary, said recognition engine comparing each handwritten input word against words in said main dictionary and providing a probability score indicative of the likelihood that each dictionary word is a correct interpretation of the handwritten input word.

7. A HUI as in claim 6, wherein said handwritten input area is located at a lower portion of said touch enabled screen.

8. A HUI as in claim 7, wherein said handwritten input area occupies less than one third of said touch-enabled screen and spans said touch-enabled screen's width.

9. A HUI as in claim 7 wherein the recognition engine is adapted to recognize handwritten entries made in cursive writing.

10. A HUI as in claim 7 wherein the recognition engine is adapted to recognize printed handwritten entries.

11. A HUI as in claim 7 further comprising:
a user dictionary supplementing said main dictionary, words in said user dictionary being matched against said each handwritten input word and assigned a probability score.

12. A HUI as in claim 7 wherein the recognition engine is adapted to recognize stylus entries made in said handwritten input area as handwritten entries and stylus entries made outside of said handwritten input area as pointer function entries.

13. A HUI as in claim 7 further comprising:
a pop-up list of word choices, during word recognition a plurality of highest scoring words are identified as most likely word recognition results, one highest scoring result is designated a primary word choice and any remaining most likely word recognition results are designated secondary word choices.

14. A HUI as in claim 13, wherein the recognition engine is adapted to define a predetermined threshold confidence level so that when said primary word choice has a confidence level above said predetermined threshold, said primary word is automatically loaded into an input buffer for delivery to an active application.

15. A HUI as in claim 7 further comprising one or more action icons on said touch-enabled screen.

16. A HUI as in claim 15 wherein said one or more action icons are displayed together on a side of said touch-enabled screen.

17. A HUI as in claim 15 including software configured so that selecting one of said action icons selects an editing operation selected from the group consisting of: inserting a space, backspacing, deleting, capitalizing recognition result, and undoing automatic insertion of a last recognition result.

18. A HUI as in claim 17 wherein said recognition engine is configured so that a stylus entry outside of said handwritten input area selects one or more characters of a previously entered word, whereby one or more characters of said previously entered word may be edited.

19. A HUI as in claim 18 further comprising a correction keyboard automatically being displayed upon selection of one or more of said action icons.

20. A HUI as in claim 19 wherein said correction keyboard is displayed in said handwritten input area.

21. A HUI as in claim 20 wherein said correction keyboard includes an add corrected word key, selecting said add corrected key adding an edited word to a user dictionary, said user dictionary supplementing said main dictionary.

22. A HUI as in claim 17, further comprising at least one configuration button icon, selecting said configuration button icon allowing the user to change configuration settings, said configuration settings comprising at least one of:
selecting handwriting style;
propose upper-case at the beginning of a word;
propose punctuation at the end of a word;
number of pop-up list recognition results;
editing button icons location; and
user dictionary maintenance.

23. A personal digital assistant (PDA) capable of recognizing handwritten words, said PDA comprising:
a touch-enabled input screen;
a recognition engine capable of recognizing handwritten words;
a main dictionary containing a plurality of words;
a communications port for communicating with a remotely connected computer, data being transferred between said remotely connected computer and said PDA;
a local storage storing said main dictionary, application data and applications to be run on said PDA;
a plurality of switches providing manual input to said PDA; and
a handwriting recognition user interface (HUI) comprising:
a designated handwriting input area residing in a lower portion of said touch-enabled input screen, handwritten words being entered a single word at a time using a stylus, recognition results being displayed on said touch enabled screen in said designated handwriting input area, stylus entries made in said designated handwriting area being handwritten entries and stylus entries made outside of said designated handwriting input area being pointer function entries,
a pop-up list listing word candidates, said recognition engine matching each handwritten input word against words in said main dictionary and providing a probability score indicative of the likelihood that each given word is a correct interpretation of the handwritten input word, all words scoring less than a highest scoring word being secondary words, and
one or more action icons displayed together on a side of said touch-enabled screen and providing access to editing functions for editing previously recognized displayed words.

24. A PDA as in claim 23, wherein said input area occupies less than one third of said touch-enabled screen and spans said touch-enabled screen's width.

25. A PDA as in claim 24 further comprising a user dictionary stored in said storage and supplementing said main dictionary, words in said user dictionary being matched against each said handwritten input word and assigned a probability score.

26. A PDA as in claim 25, wherein said HUI identifies any highest scoring word having confidence level above a predetermined threshold as a primary word and automatically loads said primary word into an input buffer for delivery to an active application.

27. A PDA as in claim 26 wherein said communications port is a wireless communications port, e-mail messages being communicated over said wireless communications port.

28. A PDA as in claim 27, wherein selecting one of said button icons selects an editing operation selected from the group consisting of: inserting a space, backspacing, deleting, capitalizing recognition result, and undoing automatic insertion of a last recognition result.

29. A PDA as in claim 27 wherein a stylus entry at a previously entered displayed word is recognized as selecting one or more characters of said previously entered displayed word, whereby one or more characters of said selected characters may be edited.

30. A PDA as in claim 29 further comprising an expansion port capable of receiving an expansion keyboard, whereby characters may be entered to correct entered words through a keyboard attached to said expansion port.

31. A PDA as in claim 30 wherein the HUI further comprises:
a correction keyboard automatically being displayed in said designated handwriting input area upon selection of one or more of said button icons.

32. A PDA as in claim 31 wherein said correction keyboard includes an add corrected word key, selecting said add corrected key adding an edited word to a user dictionary, said user dictionary supplementing said main dictionary.

33. A method of providing textual information to a computer, said method comprising the steps of:
a) receiving an entry from a designated handwritten-entry screen area;
b) passing said received entry to a handwriting recognition engine;
c) receiving a probability score from said recognition engine, said probability score indicating a likelihood for a corresponding dictionary word that said corresponding dictionary word matches said received entry; and
d) displaying a list of one or more words in descending order according to said probability score for each displayed word.

34. A method as in claim 33 further comprising the step of:
e) selecting one displayed word as a corresponding to said handwritten input.

35. A method as in claim 34 wherein said handwriting recognition engine matches said entry against words in one or more dictionaries, each word in said one or more dictionaries being assigned a probability score indicative of a likelihood that said scored word is said entry.

36. A method as in claim 35 wherein the step d) of displaying listed words further comprises the steps of:
i) determining a confidence level for a highest scoring of said matched words, any said highest scoring word having a confidence level above a selected threshold level being identified as a primary word;
ii) inserting any identified primary word into an input buffer as a primary word choice; and
iii) inserting a plurality of remaining words in a pop-up list.

37. A method as in claim 36 wherein one of said words displayed in said pop-up list is selected and displayed in place of a previously recognized displayed word.

38. A method as in claim 36 further comprising the steps of:
f) selecting an action icon for editing previously displayed words;
g) displaying a correction keyboard in said handwritten input area; and
h) editing words displayed in said other screen area, one or more characters of each edited word being replaced by characters entered from said correction keyboard.

39. A method as in claim 38 further comprising the step of:
j) storing an edited word in a user dictionary responsive to selection of a key on said correction keyboard.

40. A method of handwriting recognition for an electronic device having circuitry for running different applications, incorporating graphical interface and stylus to allow a user to interact with the application through said graphical interface, the method comprising:
providing a predetermined data entry area on the graphical user interface to receive handwritten data input, one word or character at a time;
allocating a memory buffer for the handwritten data input;
allocating a system input buffer for copying recognition data to be forwarded to an application that is active via the underlying operating system of the device;
recognizing handwritten data as words or characters;
comparing the recognition data after input in the memory buffer with data in one or more electronically stored dictionaries;
calculating recognition probability indices between associated dictionary data entries and the recognition data;
displaying candidates determined from the dictionaries as having a probability of matching the handwritten data input based on the recognition probability calculations;
prompting user intervention when said recognition probability calculations indicate the recognition data does not match a present dictionary entry;
accepting user input correcting inaccurate recognition;
modifying user-defined dictionaries in response to input of new words or characters; and
copying the correct recognition candidate to the system input buffer and forwarding the same to the active application software via the operating system.

41. The method of claim 40 wherein the said handwritten data input can be in the style of cursive, print or a mixture of both.

42. The method of claim 40 wherein said word or character input can be formed from a character string comprised of one or more members from the group consisting of alphanumeric, punctuation, symbols and control characters.

43. The method of claim 40 including editing and expanding the electronically stored user-defined dictionary.

44. The method of claim 40 including copying the recognition candidate with the highest probability to the system input buffer to be forwarded to the underlying active application without user input when said recognition candidate has a confidence level above a predetermined high threshold value.

45. The method of claim 40 including the step of selecting of the number of displayed probable recognition candidates by the user with the graphical interface.

46. The method of claim 45 wherein the probable recognition candidates are displayed in a pop-up selection list, in rank order according to the values of their respective recognition probability indices.

47. The method according to claim 46 wherein the user-selected entry or recognition candidate is copied to the system buffer, deleting the previous entry where one exists, the content of the system buffer to be forwarded to the active application.

48. A computer program product for interfacing handwritten text with a computer, said computer program product comprising a computer usable medium having computer readable program code thereon, said computer readable program code comprising:
computer readable program code means for receiving a handwritten entry;
computer readable program code means for converting said handwritten entry into a character string;
computer readable program code means for storing a plurality of correctly spelled words;
computer readable program code means for generating a probability score for each of said plurality of words, said probability score indicating a likelihood for a corresponding one word of said plurality of words that said corresponding one word matches said handwritten entry; and
computer readable program code means for selecting a list of one or more words for display in descending order according to probability score.

49. A computer program product for interfacing handwritten text with a computer as in claim 48 wherein the computer readable program code means for selecting a list of words selects one word as a primary word corresponding to said handwritten input.

50. A computer program product for interfacing handwritten text with a computer as in clam 49 wherein the computer readable program code means for selecting a list of words further comprises:
computer readable program code means for determining whether a highest scoring word of said selected words has a confidence level exceeding a selected threshold level, any said highest scoring word having a confidence level above said selected confidence level being identified as a primary word;
computer readable program code means for inserting any identified primary word into an input buffer as a primary word choice; and
computer readable program code means for inserting any said primary word and a plurality of remaining words in a pop-up list.

51. A computer program product for interfacing handwritten text with a computer as in claim 50 further comprising computer readable program code means for replacing a previously identified primary word with another one of said words in said pop-up list.

52. A computer program product for interfacing handwritten text with a computer as in claim 51 further comprising:
computer readable program code means for selecting previously displayed words for editing;
computer readable program code means for selecting a correction keyboard; and
computer readable program code means for replacing one or more characters of each edited word with characters entered from said correction keyboard.

53. A computer program product for interfacing handwritten text with a computer as in claim 52 further comprising:
computer readable program code means for storing an edited word in a user dictionary responsive to selection of a key on said correction keyboard.
